(19) United States
(12) Patent Application Publication
(10) Pub. No.: US 2013/0284463 A1
(43) Pub. Date: Oct. 31, 2013

(54) COVER FOR CONCEALED FIRE PROTECTION SPRINKLERS

(71) Applicants: Thomas Multer, Liberty, SC (US); George Polan, Liberty, SC (US)

(72) Inventors: Thomas Multer, Liberty, SC (US); George Polan, Liberty, SC (US)

(73) Assignee: THE RELIABLE AUTOMATIC SPRINKLER CO., INC., Liberty, SC (US)

(21) Appl. No.: 13/457,308

(22) Filed: Apr. 26, 2012

(51) Int. Cl. A62C 37/08

(52) U.S. Cl. 169/37

(57) ABSTRACT

An aesthetic cover is provided to conceal a cover plate of a concealed fire protection sprinkler, the cover plate having an inner side facing the sprinkler and a wall or ceiling surface and an outer side facing away from the sprinkler. The cover includes a concealing surface and an attachment member configured to attach the concealing surface to the cover plate so as to conceal the cover plate.

### BACKGROUND OF THE INVENTION

1. Field of the Invention

Fire protection sprinklers are conventionally used in commercial and residential occupancies. Such sprinklers typically include components which, in visible sight to those within the occupancy, are considered by many to be unsightly, especially in residential occupancies. At least one solution to this problem has been a concealed sprinkler, which can be covered using a sprinkler cover plate, such as those provided in U.S. Pat. No. 6,374,919 (Neill). Flat concealed sprinkler cover plates have been in existence since the late 1970's, and in the mid 1990's various manufacturers began marketing deep-drawn covers (with truncated conical protrusions) which hid non-adjustable frame sprinklers in both pendent (ceiling) and horizontal sidewall (wall) models. While such covers are effective at concealing the sprinkler, the covers themselves remain visible and, by some, are considered to be little more appealing to view than the sprinkler itself. In particular, many architects dislike the look of these wall/ceiling covers, and some derisively term them blemishes or “pimples” that mar the otherwise flat surfaces of an occupancy.

Concealed sprinkler covers for ceilings are often much less obtrusive than concealed covers for sidewall sprinklers. The much more pleasing flat cover plates mandate usage of deployable/drop-down deflector assemblies, such as those described in U.S. Pat. No. 7,275,603 (Polan). The flat cover plates are generally acceptable for ceiling-type sprinklers, since gravity aids in the downward movement of the deployed deflector and the activated components of the seal mechanism. Moreover, for ceiling-type sprinklers, heat penetration between the recessed area above ceiling line sprinkler sensor assembly is facilitated due to the vertical orientation of the sprinkler and cover. However, in the case of sidewall sprinklers, the sensor and the deflector of the sprinkler often must protrude beyond the surface of the wall into the occupancy to sense the rising hot air from a fire condition, to ensure the required sprinkler activation time. As such, the concealed cover for these sidewall sprinklers is often limited to the obtrusive truncated cone protrusion described earlier.

In addition, the sensitivity of a sprinkler can be affected by covering the sprinkler with a cover plate. As such, concealed sprinklers are designed and tested to have a predetermined sensitivity when configured with an approved concealed sprinkler cover plate. Conventionally, such concealed sprinklers and cover plates are tested according to relevant standards promulgated by Underwriters Laboratories and Factory Mutual. For example, current UL listings stipulate that the minimum rated temperature of ceiling/wall covers and the operating elements of automatic sprinklers shall be 135° F. (57° C.) when the expected ceiling temperatures do not exceed 100° F. (38° C.)—UL Standard 199, section 9, Temperature Ratings. Accordingly, typical sidewall concealed (SWC) covers are available in temperature ratings of 135° F. and 165° F., and carry UL listing for installations in the range of 4″-12″ below the ceiling. Current UL listing criteria require that a quick response (QR) rated horizontal sidewall concealed sprinkler installed between 4 and 12 inches below the ceiling must achieve complete activation of the cover plate and thermal release element (e.g., bulb or soldered link) within seventy-five (75) seconds when tested in accordance with UL Standard 199, Section 31—Room heat test for QR and QR extended coverage sprinklers. The cover plates are generally attached to the sprinkler by a heat-sensitive connection such as an adhesive or fusible solder that will, when combined with the weight and position of the cover plate, fall away from the sprinkler just prior to the activation of the sprinkler. Adding weight to the cover may weaken the connection of the cover plate to the sprinkler, however, and cause the cover to fall off sooner than designed, revealing the previously concealed sprinkler when no fire condition exists. Thus, rather than being concealed, the sprinklers would be undesirably visible.

### SUMMARY OF THE INVENTION

To solve some of the above aforesaid problems, an aesthetically pleasing cover is provided to conceal a cover plate of a concealed sprinkler, such as the cover plate described in U.S. Pat. No. 6,374,919 (Neill), the entire contents of which are incorporated herein by reference. In one embodiment the aesthetic cover is configured to hide the concealed sprinkler cover plates, such as, for example, the flat and the deep-drawn conical, spherical protrusions used for sidewall sprinklers, via the attachment of an aesthetically pleasing cover assembly. In one embodiment the aesthetic cover is configured to resemble a wall audio speaker screen. In another embodiment the aesthetic cover is configured to resemble a lighting sconce. It will be appreciated that while the preferred embodiments herein are described with particular reference to use with sidewall fire protection sprinklers, they are equally applicable to other concealed sprinklers, and in particular to pendent concealed sprinklers.

According to one aspect of the invention an aesthetic cover is provided to conceal a cover plate of a concealed fire protection sprinkler, the cover plate having an inner side facing the sprinkler and a wall or ceiling surface and an outer side facing away from the sprinkler. The aesthetic cover includes a concealing surface, and an attachment member configured to attach the concealing surface to the cover plate so as to conceal the cover plate from view. The concealing surface and the attachment member may be formed of a plastic or metal material. Preferably the concealing surface and the attachment member are lightweight so as not to put stress on the connection between the cover plate and the sprinkler that would affect the operation of the cover plate. Examples of materials that the attachment member and the concealing surface may be formed from include aluminum and polypropylene, although other suitable metals and plastics may be used, as will be appreciated by one of skill in the art. The concealing surface of the aesthetic cover may be configured as a screen having at least one aperture formed therein. Moreover, the concealing surface may be planar or curvilinear such as to conform to the shape of the outer surface of the cover plate.

The aesthetic cover for the cover plate is configured to retain the Underwriters Laboratories/Factory Mutual tested and documented Cover Plate/Sprinkler Sensitivity (activation times). Moreover, the aesthetic cover for the cover plate is configured to have a weight that does not stress any connection, such as soldered joints, between the cover plate and the sprinkler. These and other benefits will be appreciated to one of skill in the art based on the following description.

### DESCRIPTION OF DRAWINGS

FIG. 1 is an isometric view of an aesthetic cover viewed from the front and side of the cover in accordance with an embodiment of the invention.

FIG. 2 is an isometric view of the aesthetic cover of FIG. 1 shown with a concealing surface of the aesthetic cover removed.

FIG. 2A shows a view through a section 2A-2A shown in FIG. 2.

FIG. 2B shows a view through a section 2B-2B shown in FIG. 2.

FIG. 3 is a front elevation view of the concealing surface shown in FIG. 1.

FIG. 4 shows a front elevation view of the aesthetic cover of FIG. 2 shown connected to a cover plate of the sprinkler.

FIG. 5 shows a plan view of the arrangement of the aesthetic cover and cover plate shown in FIG. 4.

FIG. 6 shows an isometric view of another embodiment of an aesthetic cover viewed from the front and a side of the cover.

FIG. 7 shows an isometric view of the aesthetic cover shown in FIG. 6 viewed from the side and front of the cover.

FIG. 8 is an isometric view of the pendent fire protection sprinkler of the present invention.

FIG. 9 is a sectional view of the sprinkler installed in the support cup, with the deflector in the deployed position.

FIG. 10 is a sectional view of the sprinkler and support cup, showing the levers and fusible link.

FIG. 11 is an isometric view of the fusible link.

FIG. 12 is an isometric view of a lever.

FIG. 13 is an isometric view of the underside of the sprinkler body.

FIG. 14 is an isometric view of the load yoke.

FIG. 15 is a sectional view of the sprinkler body showing the housing members of the deflector support members.

FIG. 16 is an isometric view of a rod that forms part of the deflector support member.

FIG. 17 is an isometric view of the deflector.

FIG. 18 is a sectional view of the deflector and the conical member.

FIG. 19 is an isometric view of the sprinkler installed in the support cup, escutcheon, and cover assembly.

FIG. 20 is a sectional view of the embodiment of the pendent sprinkler of FIG. 8 installed in a ceiling.

FIG. 21 is a concealed horizontal sidewall sprinkler assembly.

### DETAILED DESCRIPTION

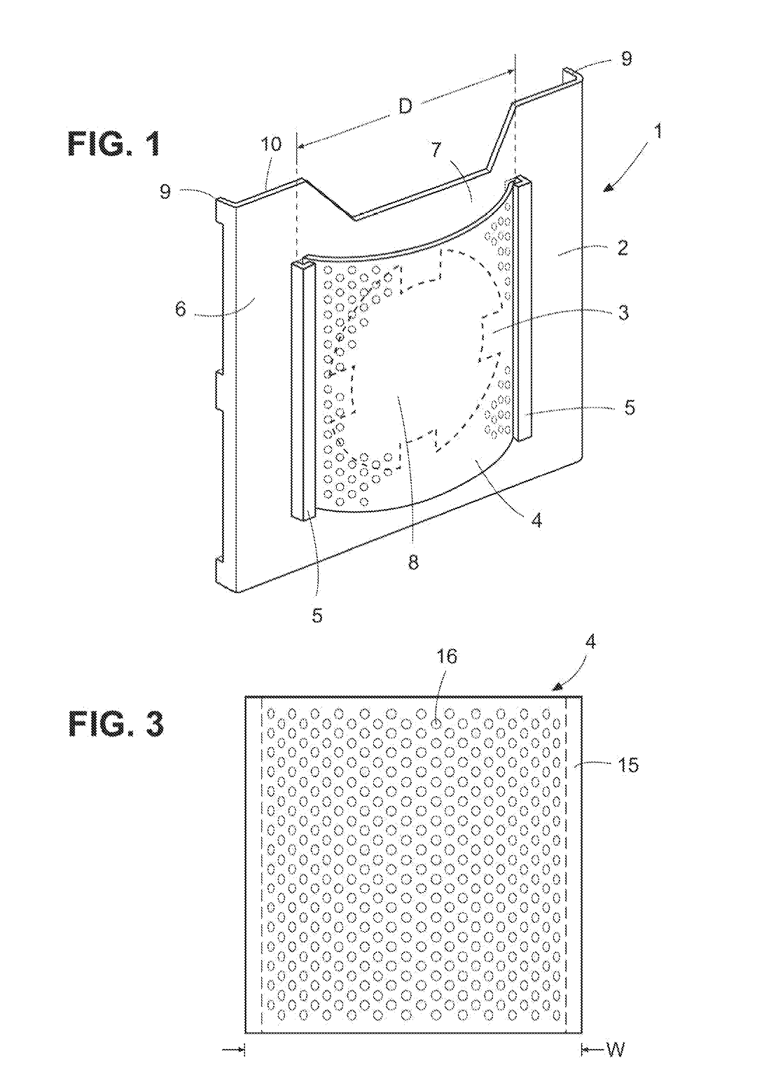

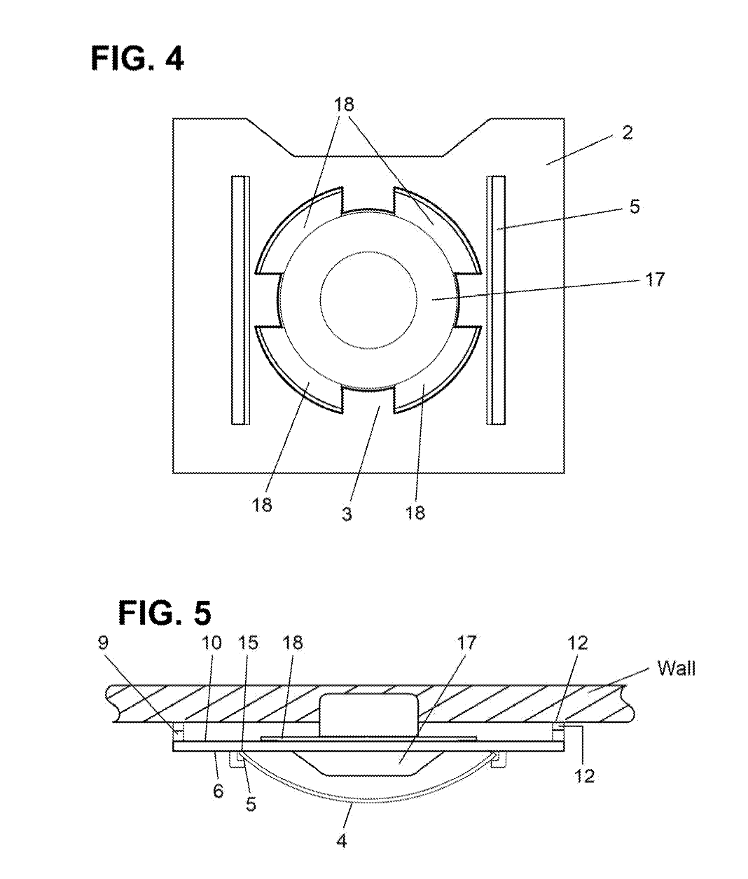

FIG. 1 shows one embodiment of an aesthetic cover 1 in accordance with the first preferred embodiment of the invention. The aesthetic cover 1 includes an attachment member 2 having tabs 3 (shown in dotted lines) configured to align and attach the attachment member 2 to at least a portion (e.g., rim 18, FIGS. 4 and 5) of a cover plate 17 (FIGS. 4 and 5) of a concealed sprinkler (not shown). The aesthetic cover 1 also includes a concealing surface 4 configured to attach to the attachment member 2. The concealing surface 4 is retained in two slots 5 formed in the attachment member 2. The concealing surface 4 is shown as having a generally planar member that is curved or bowed and extends away from a front side 6 of the attachment member 2, forming a gap 7 between the concealing surface 4 and the first side 6 of the attachment member 2. The gap 7 allows air to circulate between the concealing surface 4 and the cover plate 17 (FIGS. 4 and 5). Air circulation in the gap 7 helps to mitigate any impact of the aesthetic cover affecting the listed sensitivity (i.e., activation timing) of the sprinkler to detecting a fire and activating within the desired and listed time (e.g., 75 seconds). The attachment member 2 includes sides 9, which extend from the rear side 10 of the attachment member 2 a certain predetermined distance.

The concealing surface 4 and the attachment member 2 may be formed of a suitable plastic or metal. Preferably the concealing surface and the attachment member are lightweight so as not to put stress on the connection between the cover plate 17 (FIGS. 4 and 5) and the sprinkler that would affect the operation of the cover plate 17. Examples of materials that the attachment member 2 and the concealing surface 4 may be formed from include aluminum and polypropylene, although other suitable metals and plastics may be used, as will be appreciated by one of skill in the art. In the case of metals, the metals preferably do not contain lead.

In at least one embodiment, the concealing surface 4 is configured as a screen having at least one aperture formed therein. Moreover, the concealing surface may be configured to be formed as a planar or curvilinear element such as to conform to the shape of the outer surface of the aforementioned cover plate 17.

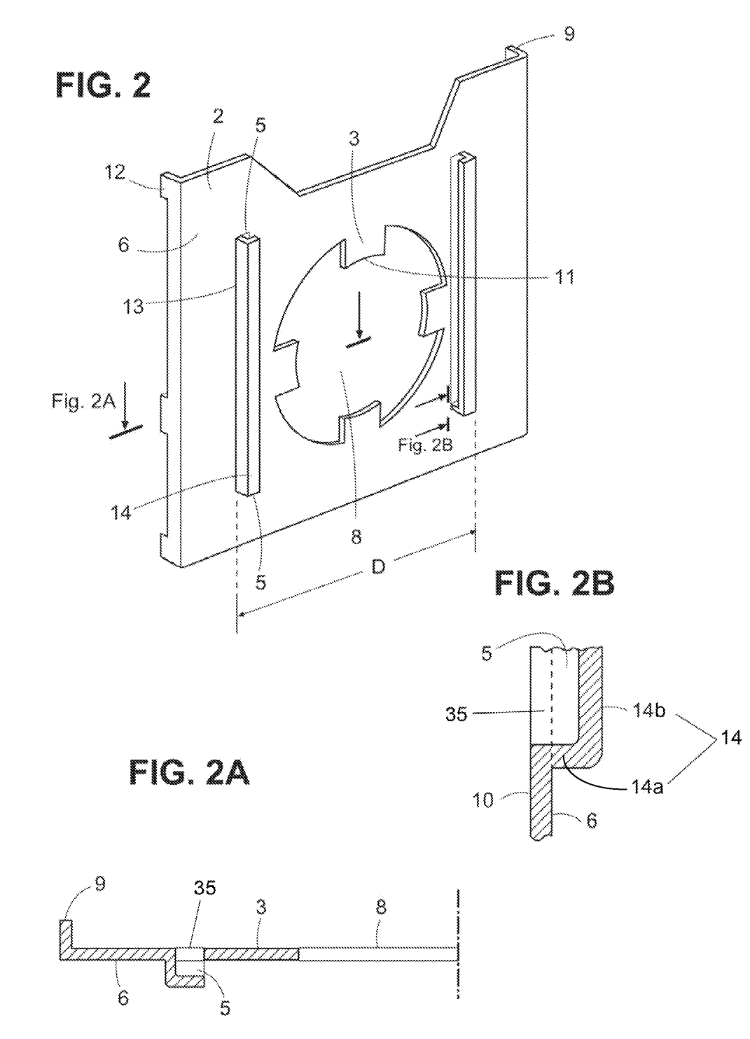

FIG. 2 shows a view of the attachment member 2 with the concealing surface 4 of FIG. 1 removed. An opening 8 is formed in the attachment member 2 having a generally circular shape and has at least one tab 3 extending radially inwardly from the edge of the opening 8. In the illustrated version, four such attachment tabs 3 are provided, and are spaced apart circumferentially from each other. The four tabs 3 are equally spaced from each other and extend radially inwardly substantially equal amounts. The planar tabs 3 are configured to attach to a portion of the cover plate of the concealed sprinkler. Preferably the tabs 3 are equal in length so as to center and attach the tabs to the cover plate as is shown in FIG. 4. The rear facing sides of the tabs 3 are also preferably configured to attach to the cover plate 17, preferably with an adhesive. In one example, paper-backed pressure-sensitive adhesive tape is applied to the rear facing tabs such that the paper backing can be removed prior to connecting the tabs 3 to the cover plate 17.

FIG. 2A shows a view of one of the sides 9 as viewed along section A-A of FIG. 2. The sides 9 extend rearwardly a predetermined amount, which preferably is sufficient to permit a portion of the sides 9 to contact the wall/ceiling from which the concealed sprinkler and cover plate 17 extend when the attachment member 2 is attached to the cover plate 17 (FIG. 5). In one preferred embodiment the flange extends about 0.17 inches from the rear side 10 of the attachment member 2. Optionally, as shown in FIGS. 1, 2, and 5, the sides also may include at least one standoff 12 further extending from the leading edge of each of the sides 9, which are configured to contact the wall/ceiling. In one preferred embodiment the standoffs 12 extend about 0.02 inches from the leading edge of the side 9. The standoffs are preferably configured to minimize the surface area of the leading edge of the side 9 in contact with the wall/ceiling around the sprinkler. Minimizing the contact area between the sides 9 and the wall/ceiling helps limit adhesion between the sides 9 (and therefore the aesthetic cover 1) and the wall/ceiling if, for example, paint is applied to the wall/ceiling and inadvertently between the sides 9 and the wall/ceiling. Such adhesion could delay or prevent the aesthetic cover 1 and concealed sprinkler cover plate 17 from disconnecting from the concealed sprinkler within the appropriate time in the event of a fire condition, thereby possibly altering the approved sensitivity listing of the sprinkler.

The two elongated slots 5 shown in FIGS. 1 and 2 are configured to receive and retain the concealing surface 4 in the curved condition shown. The slots 5 shown in FIGS. 1 and 2 are substantially parallel to each other, although it will be appreciated by one of skill in the art that the slots may be angled with respect to each other in other embodiments. The two elongated slots 5 extend on opposite sides of the opening 8 and are separated from each other by a predetermined distance D.

As shown in FIG. 2A the slots 5 are defined by the front side 6 of the attachment member 2 and an “L” shaped channel 14 having a base 14a extending from the surface of the attachment member 2 along an elongated edge 13 of the channel 14 and having a flange 14b extending from the base generally parallel with the surface of the attachment member 2. The resulting slots 5 have a generally rectangular-cross section to be capable of at least partial engagement with an edge 15 (FIG. 3) of the concealing surface 4. The edge 15 and the slot 5 may be configured to engage each other securely by virtue of an interference fit, and may be configured to be detachably secured together. Such detachable connection may facilitate removal of the concealing surface 4 for cleaning, painting, or replacement. Removability of the concealing surface 4 also permits changing of the concealing surface to match a new decor if the room is redone. In alternate embodiments the slot 5 may have other cross-sectional shapes, including, but not limited to, rounded, angular, or keyed shapes. Likewise, the edges 15 may be configured to have a profile that is complimentary to the slot 5. The slots 5 and or the concealing member 15 may also be configured to have a tapered cross-section along their length to provide for unidirectional assembly. Of course, the concealing surface 4 may be permanently secured to the attachment member 2, such as with an adhesive or fastener. It should be noted that in other embodiments, the concealing surface 4 and attachment member 2 are combined to form a unitary structure. As discussed above, such a unitary structure may be formed from metal or plastic.

As shown in FIGS. 1 and 5, the edges 15 of the concealing surface 4 are in contact with the leading edge of the channel 14 and at the corner between the trailing edge of the channel 14 and the front side 6 of the attachment member 2.

Two elongated openings 35 are formed in the attachment member 2 opposite the flange 14b. The elongated openings 35 extend generally parallel to the channel 14. The elongated openings 35 permit the attachment member 2 to be extracted from a mold, if the attachment member is formed in a molding process, such as a plastic molding process.

FIG. 2B shows a view of the slot 5 along section B-B of FIG. 2 at the bottom of the slot 5. The slot 5 is shaped to positively stop or limit movement of the concealing surface 4 within the slots, for example by being closed at its lower end, as shown in this Fig. Of course, other configurations of stops are possible. For example, in another embodiment (not shown) detents or protrusions are formed extending from the front side 6 of the attachment member 2 above and below the slot 5, which can be configured to extend from the front side 6 a sufficient amount to further limit movement of the concealing surface 4 when it is retained in the slots 5. Still other configurations may be adopted as being equivalents of one or more of the listed ones.

FIG. 3 is a front view of an embodiment of the concealing surface 4 shown in FIG. 1. The concealing surface 4 can be formed from a planar sheet, and may be formed from metals including aluminum, steel, and brass. In a preferred embodiment, the concealing surface 4 is formed from aluminum. In addition, the concealing surface 4 may also be formed from plastics, such as polypropylene and polyvinyl chloride (PVC). In one embodiment the concealing surface 4 is formed as a plastic sheet having a thickness of about 0.030 inches. Such materials can preferably be coated or painted to match a specific color and/or texture desired. The concealing surface 4 includes a plurality of apertures 16 that allow air to pass therethrough. Although the edges 15 are shown without apertures formed therein, in other embodiments, the edges may include such apertures 16.

The concealing surface 4 is preferably a planar element having a uniform thickness that is suitable to be bowed when engaged between the retaining slots 5 of the attachment member 2 as shown in FIGS. 1 and 5. The width W of the concealing member 4 is preferably greater than the distance D between the slots 5 so that the concealing member 4 will bow or bulge away from the front side of the attachment member 2 when the concealing member 4 is received in the slots 5 Moreover, the concealing surface 4 can be a flexible and resilient member such that it can return to a bowed shape (such as that shown in FIG. 1) if the concealing surface 4 is pushed or otherwise disturbed while attached to the attachment member 2. As shown in FIGS. 1 and 5, the edges 15 are in contact with the leading edge of the channel 14 and at the corner between the trailing edge of the channel 14 and the front side 6 of the attachment member 2. Of course, the concealing surface 4 can be formed to retain its net shape when not received in channel 14. For example, in one embodiment, the surface 4 can be formed as a plastic formed having a net shape as shown in FIG. 1. Likewise, in another embodiment, the surface 4 can be formed from a metal having a net shape as shown in FIG. 1.

FIG. 4 shows a front elevation view of the attachment member 2 shown in FIGS. 1 and 2 attached to a cover plate 17 of a concealed sprinkler. The concealing surface 4 is not shown, for clarity of illustration. As shown in FIG. 4, the attachment member 2 is configured to receive a portion of the cover plate 17 through the opening 8. The cover plate 17 shown is configured having a frustoconical outer surface having an annular rim 18 at its larger diameter base end and can be constructed as described in U.S. Patent No. 6,374,919 (Neill). As provided in Neill, when attached to the concealed sprinkler, the rim 18 is configured to be disposed at a certain predetermined distance from the wall or ceiling (FIG. 5) in which the concealed sprinkler is installed to facilitate air flow between the cover plate 17 and the sprinkler, such that ambient conditions around the sprinkler cover can be sensed by the thermally-responsive element of the sprinkler. The attachment member 2 is positioned over and around the cover plate so that the cover plate 17 passes through the opening 8 and the tabs 3 contact the rim 18. The tabs 3 are preferably configured to attach to the rim 18 with an adhesive, such as glue or double-sided adhesive tape. Such adhesive is preferably applied to the rear facing sides of the tabs 3 such that the attachment member can be attached over the cover plate 17 from the front of the cover plate 17. In yet another embodiment, the tabs 3 may be configured to engage or snap into corresponding slots formed on the surface of the cover 17. Of course one of skill in the art will appreciate that other methods of attachment of the attachment member 2 to the cover plate 17 are possible and are within the scope of the invention. By virtue of the features of these and other embodiments, it may be possible to retrofit an existing cover plate 17 of a concealed sprinkler with an aesthetic cover 1 described herein. While the attachment member 2 and concealing surface have been described as separate attachable components that can be attached to the cover plate 17 of a concealed sprinkler, it will be appreciated that the aesthetic cover 1 can also be formed integrally with the cover plate 17 as a monolithic member.

FIG. 5 shows a plan view of the arrangement of the attachment member 2 attached to the cover plate 17 shown in FIG. 4 as viewed from a position above the aesthetic cover 1. The concealed surface 4 extends a sufficient amount from the front side 6 of the attachment member 2 to avoid contact with the cover plate 17.

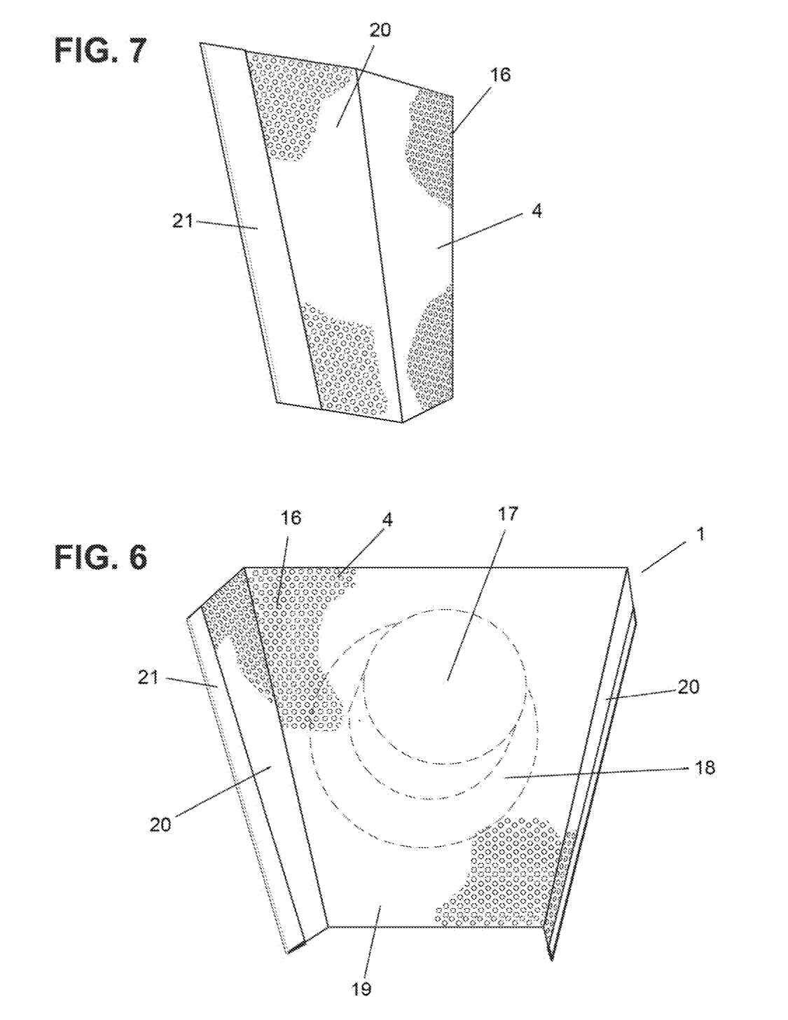

FIG. 6 shows another embodiment of the aesthetic cover 1. The aesthetic cover 1 includes a concealing surface 4 formed by three planar sides. As viewed from the front side, the aesthetic cover 1 has a generally vertically tapered V-shape being wider at the upper edge and narrower at the lower edge, which in many ways resembles an architectural wall sconce for lighting fixtures. The concealing surface 4 shown is formed as a three-sided perforated screen having a plurality of apertures 16 formed therein, which allow airflow therethrough. The front side of the concealing surface 4 is attached to the outer end surface of the cover plate 17 of the concealed sprinkler along an inner side of the concealing surface 4. By virtue of this arrangement, instead of connecting the concealing surface 4 to the attachment member 2 in the embodiment in FIG. 1, the front side of the concealing surface 4 shown in the embodiment in FIG. 6 acts as both a concealing surface 4 and as an attachment member 2. The concealing surface 4 may be attached directly to the cover plate 17, such as, for example, with an adhesive or glue.

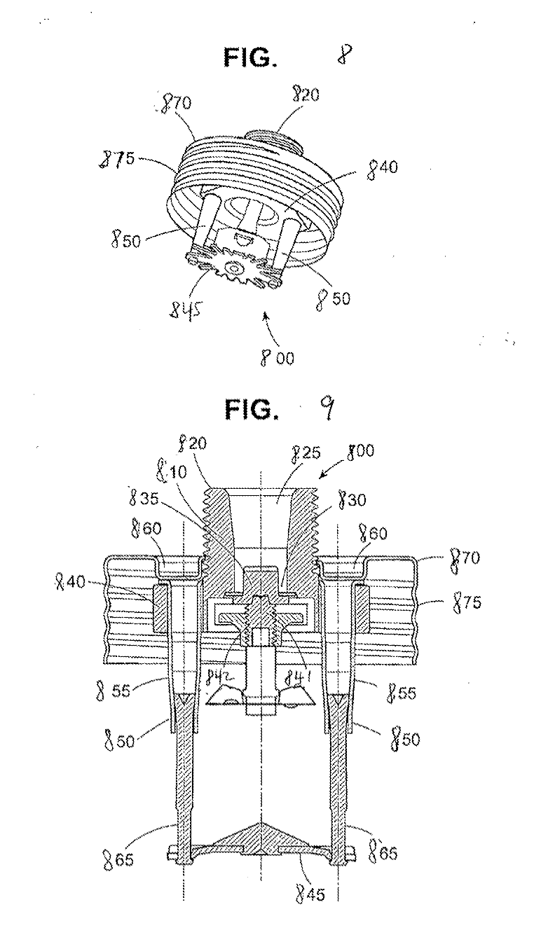

As shown in FIG. 7, two other sides 20 of the concealing surface 4 shown in FIG. 7 face each other and wrap around the cover plate 17 and extend rearward from the front side 19 of the screen towards the wall or ceiling (not shown). The sides 20 are similar in function to sides 9, described above, as disposing the front side of the concealing surface 4 a predetermined distance from the wall. Leading edges of the sides 20 are preferably configured to have a smooth edge 21. The smooth edge 21 can be provided by coating the leading edge of each of the sides 20 with a material, such as, for example, Teflon® or nylon. The edging 21 can minimize adhesion of the edges of the concealing surface 4 to the wall or ceiling surface if, for example, paint is applied inadvertently between the wall and the aesthetic cover 1. While the edging 21 is shown as extending along the entire leading edge of the sides 20, in at least one other embodiment, the edging may extend less than the entire length of the leading edge. The edging 21 may be configured as a pre-formed channel. The leading edge of the concealing surface 4 can be configured to be disposed and held fast in the channel by virtue of at least one of an adhesive, an interference fit, and a fastener. In other embodiments, the smooth edge 21 is integrally formed with the concealing surface, such as by forming the entire concealing surface and edge 21 out of a single piece of metal, Teflon®, or nylon.

Typically, sidewall concealed (SWC) cover plates 17 are listed based on a pre-determined temperature rating (e.g., 135° F. and 165° F.) at which the cover plate 17 should fall off. Typically, the temperature rating of the cover plate is configured to be the same as the temperature rating of the thermal-release element of the sprinkler (e.g., 135° F. and 165° F.). Preferably, however, the cover plate 17 is configured to be released from the sprinkler prior to sprinkler activation. In the case of horizontal concealed sprinklers, sprinklers installed 4 to 12 inches below the ceiling must achieve complete release of the cover plate 17 and activation of thermal-release element (e.g., bulb or soldered link) within a pre-determined time limit (e.g., seventy-five (75) seconds) when tested in accordance with UL Standard 199, Section 31—Room heat test for QR and QR extended coverage sprinklers. However, it has been observed through testing, that attachment of the aesthetic cover 1 to the cover plate 17 may alter the thermal sensitivity of the release of the cover plate 17 from the sprinkler and the activation of the thermal-release element, and thereby may alter the response time of the concealed sprinkler. Moreover, it has been observed through testing that the time to achieve complete release of the cover plate 17 and activation of thermal-release element of the concealed horizontal sprinkler (e.g., bulb or soldered link) can also be affected by the distance between the installed sprinkler and the ceiling. Generally, the time to achieve complete release of the cover plate 17 and activation of thermal-release element response time increases as the sprinkler is installed closer to the ceiling and farther from the area of heat release below the sprinkler.

To address this problem of lengthened cover plate 17 release time and lengthened sprinkler activation times, a dual-cover assembly may be provided that, in one embodiment, includes an aesthetic cover 1 that is configured to attach to a cover plate 17 which has an ejection mechanism that is configured to ensure complete and timely ejection of the cover plate 17 prior to actuation of the thermal-release element of the sprinkler at a lower temperature than the thermal-release element. By virtue of the lower temperature release of the cover plate 17 from the sprinkler, the time to achieve complete release of the cover plate 17 and activation of thermal-release element can be limited to be within the listed time required by UL Standard 199 (i.e., 75 seconds) for installations within the listed installation range with respect to the ceiling. In a first embodiment of the dual cover assembly, the ejection mechanism is a thermally-fused connection between the cover plate 17 and the sprinkler which is configured to release the cover plate 17 at a temperature below the activation temperature of the thermal-release element of the sprinkler. In a more preferred embodiment, the cover plate 17 is constructed similarly to the cover plate according to U.S. Pat. No. 6,374,919 (Neill) in which, in one embodiment, a cover 50 is attached by solder 66 to tabs 64 extending from a flange 62 of a sleeve 48 (see, e.g., the '919 patent, FIGS. 1 and 3). The sleeve 48 is connected to a cover support 44, which is connected to the sprinkler body 12. In the present dual cover assembly, the solder is configured to fuse or liquefy at a predetermined temperature below the actuation temperature of the thermal-release element of the sprinkler. Preferably, the predetermined temperature rating of the fusible solder is 120° F., which is lower than the 135° F. conventionally in use.

Such a lower-temperature cover/sleeve sub-assembly for the dual cover assembly can be used to retrofit existing cover/sleeve assemblies configured according to the '919 patent in order to attach the aesthetic cover 1. The lower temperature rated cover/sleeve sub-assembly would preferably include an adhesive, such as a pressure sensitive adhesive tape, or other attachment means, to attach the aesthetic cover 1 to the cover/sleeve assembly positioned as shown, for example, in FIGS. 1, 4, 5, and 6. In one embodiment a cover plate attachment guide is provided to facilitate the alignment of the aesthetic cover 1 relative to the sprinkler cover 17 and between the cover/sleeve sub-assembly and the cover support.

Among other benefits of reducing the sprinkler cover 17 release temperature rating is that the cover plate 17, along with any attached aesthetic cover 1, will be released before the sprinkler activates. As discussed above, extended coverage (EC) sprinklers are typically manufactured with a cover plate 17 that fuses at the same temperature (e.g., 135° F.) as the thermal release element of the sprinkler. A problem that is occasionally encountered with such extended coverage (EC) type sprinklers during room sensitivity testing, is that the thermal element of the sprinkler may activate before the sprinkler cover plate 17 is released. Configuring the cover plate 17 to release at a markedly lower temperature than the sprinkler (e.g., 120° F. instead of 135° F., for example) can provide greater assurance that the sprinkler cover plate 17 and aesthetic cover 1 will both be released prior to activation of the thermal-release mechanism of the sprinkler.

Another benefit of the retrofit dual-sprinkler cover assembly is that it will provide an end user with the ability to paint the unattached aesthetic cover 1 prior to its attachment to the cover plate 17 of the sprinkler. For example, the aesthetic cover 1 can be painted and/or textured to match the surrounding surface of the wall from which the aesthetic cover extends.

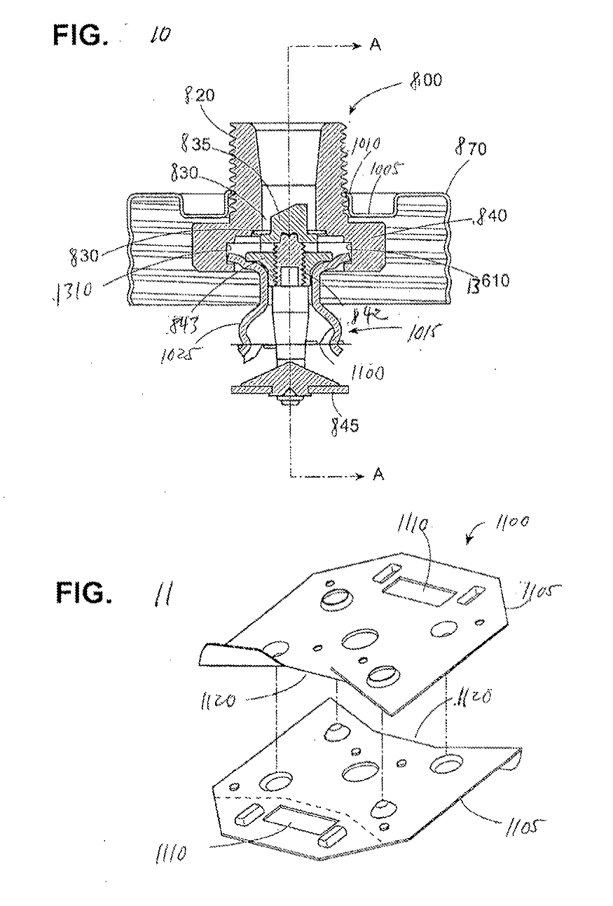

As shown in FIGS. 8 and 9, an embodiment of a pendent fire protection sprinkler 800 is provided which has a body 810 with a threaded base 820 for connection to a conduit (not shown) for supplying pressurized fire-extinguishing fluid, such as water. The body 810 has an axial bore 825 with an outlet orifice 830 from which the fluid is output upon release of a seal cap 835. The output orifice 830 may have a diameter of, for example, ⅜ or 7/16 inch. The sprinkler may have a nominal K-factor of, for example, 4.3 or 5.6, respectively, which is defined by K=Q/\sqrt{p}, where Q is the flow rate in gallons per minute and p is the residual pressure at the inlet of the sprinkler in pounds per square inch. The body 810 also has a hexagonal, rectangular, or other polygonal shaped flange 840 around its output end. The body is preferably formed from a metal, including brass, stainless steel, and copper. In one embodiment the body is formed from a metal that does not include lead.

A deflector 845 is coupled to two deflector support members 850 on opposite sides of the sprinkler body 810. Each of the support members 850 includes a housing member 855, which extends downward from the flange 840 of the sprinkler body 810, and a rod 865, which is movable with respect to the housing member 855.

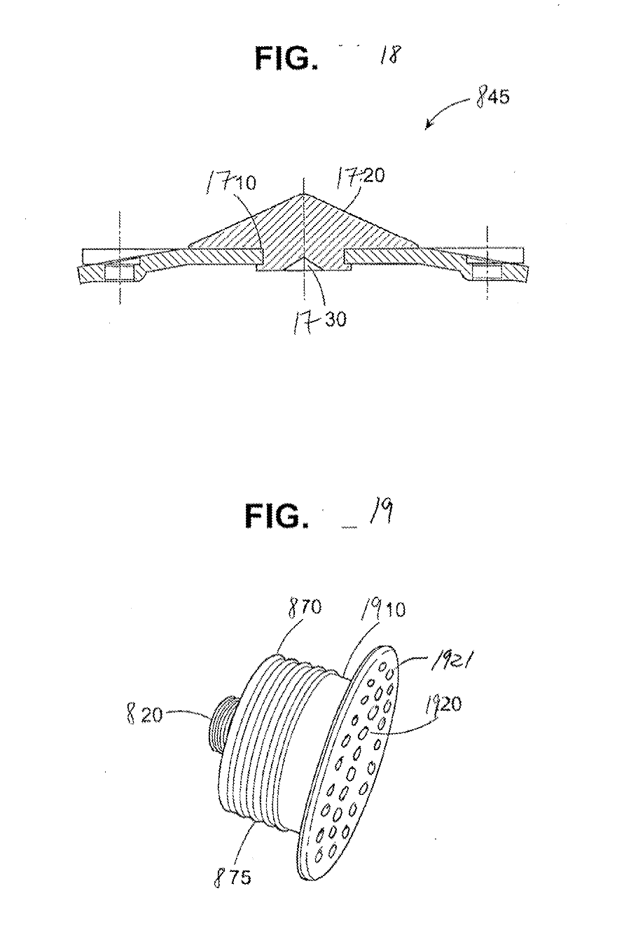

For example, the housing member 855 may be a tubular structure positioned within and extending downward from a hole 860 in the flange 840, and the rod 865 may be a solid, generally cylindrical member contained within the housing member 855. However, numerous other configurations for the housing members 855 and rods 865 also are possible. For example, the rods 865 may be tubular members, rather than solid members. Although the configuration of one embodiment of the housing members 855 and rods 865 are shown in FIGS. 15 and 16, other shapes are possible as well, e.g., square, hexagonal, cylindrical, telescopic, etc. In addition, although in the embodiment shown in FIGS. 15 and 16 the flange 840 and housing members 855 are separate components, the present invention is not so limited, and those components may be configured as a unitary structure or having multiple components.

During operation, the rods 865 slide from an initial position, in which a large portion of the length of the rod 865 is within the housing member 855 (as shown in FIG. 1) to a deployed position, in which a substantial portion of the length of the rod 865 extends from the bottom of the housing member 855 (as shown in FIG. 9). Accordingly, in the deployed position, the deflector 845 moves downward along with the rods 865 (see FIG. 9).

The sprinkler 800 is mounted in a support cup 870 having a cylindrical, threaded outer wall 875, which surrounds a portion of the installed sprinkler 800 and, as discussed below, allows for installation into a ceiling cavity. The support cup 870 also has a mounting platform 1005 (FIG. 10) with a hole in the center into which the sprinkler body 800 is inserted. The hole has a threaded rim portion 1010 or tabs configured to interlock with the threads of the sprinkler base 820.

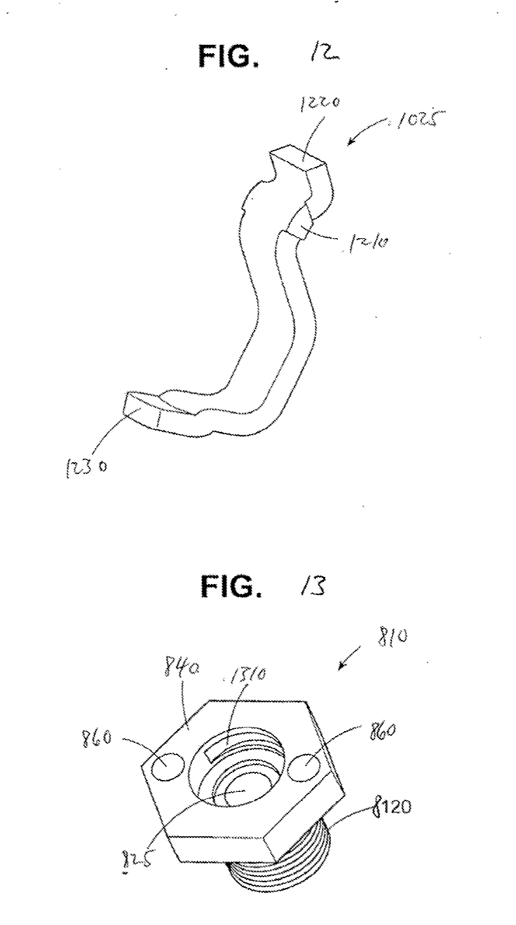

As shown in FIG. 10, the sprinkler also has a thermally-responsive element 1015 that holds the seal cap 835 in place over the output orifice 830, e.g., a fusible soldered link 1100 attached to the ends of two levers 1025. As shown in FIG. 11, the link 1100 comprises two thin, metal plates 1105, e.g., beryllium-nickel alloy. The plates 1105 overlap such that a rectangular opening 1110 in each plate 1105, in which the ends of the levers 1025 are positioned, is aligned with a slot 1120 or open portion in the other plate 1105. The plates 1105 are attached with solder that melts at a predetermined temperature. The link 1100 separates at the predetermined temperature, due to the force applied by the levers 1025, allowing the levers 1025 to swing outward (FIG. 10). This in turn releases the seal cap 835 and allows the fluid to be output from the orifice 830. Of course, other types of thermally-responsive elements may be used, including, but not limited to, for example, a frangible bulb and lever assembly, or a sensor, strut, and lever assembly.

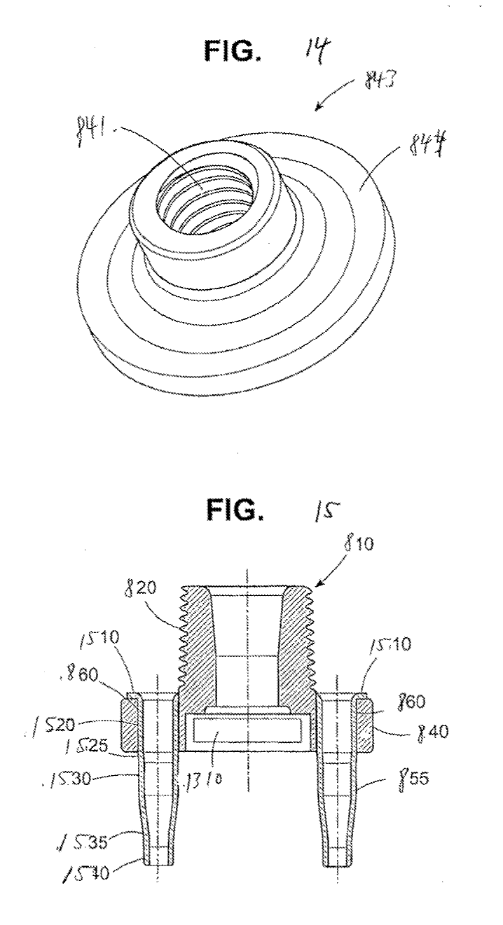

Each lever, as shown in FIG. 12, is an elongated, thin, metal member, e.g., copper alloy with a thickness of about 0.050 inches. Each lever 1025 has a wider tab portion 1210 located near the end 1220 that inserts into one of the openings 1110 in the link plates 1105. The tab portion 1210 rests against the plates 1105, so as to maintain the position of the lever 1025 with respect to the plates 1105. The other end 1230 of each lever 1025 is inserted into one of a pair of arcuate, rectangular slots 1310, as shown in FIG. 13, formed inside the bore 825 on either side of the outlet orifice. The slots 1310 are positioned 90° apart from the deflector support members 850 in the plane of the flange 840.

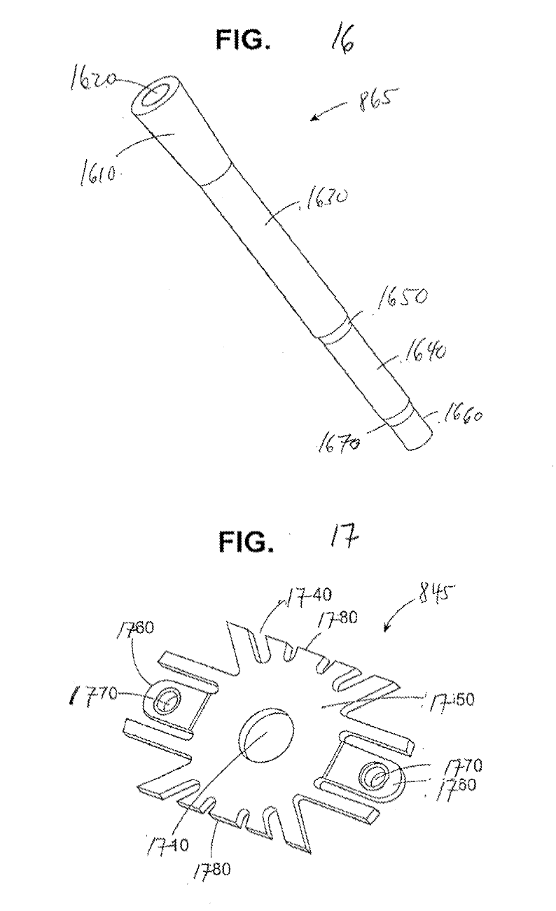

Referring again to FIG. 10, the levers 1025 swing outward upon release of the fusible link 1100 due to the force of the fluid in the conduit against the seal cap 835 and a pre-tension force supplied by a loading yoke 843, as shown in FIG. 14. The seal cap is preferably formed from the same materials as the body 810. The loading yoke 843 is a cylindrical member with a threaded bore 841 and a circumferential flange 844 at one end. A load screw 841 (FIG. 10) extends completely through the bore 841 of the yoke 843 and rests in an indentation in the seal cap 835. The yoke 843 is forced against the levers 1025 by the tightening of the load screw 841 against the seal cap 835, thereby forcing the levers 1025 away from one another.

As shown in the cross-sectional view of FIG. 15, the housing members 855 of the deflector support members 850 are positioned in through-holes 860 formed in the flange 840 of the sprinkler body 810, such that their axes are spaced apart by about 1.125 inches. Each housing member 855 is about 1.13 inches in length and is formed of thin metal, e.g., copper alloy. The top end of each housing member 855 has a flange 1510 to hold it in place. The outer perimeter of this flange 1510 is circular, with a cutout to allow the housing member 855 to be positioned closer to the sprinkler body 810.

At the top of each housing member 855 (i.e., the flanged end) is a first cylindrical portion 1520, which is about 0.35 inches in length and about 0.26 inches in diameter. This is followed by a first frustoconical portion 1525 having a length of 0.08 inches and forming an angle of about 8.0° with respect to the longitudinal axis of the housing member. A second cylindrical portion 1530 adjoins, with a diameter of about 0.25 inches and a length of 0.20 inches. This is followed by a second frustoconical portion 1535 having a length of 0.35 inches and forming an angle of about 8.6° with respect to the axis of the housing member. A third cylindrical portion 1540 is provided at the end of the housing member 855, which has a length of about 0.11 inches and a diameter of about 0.2 inches.

As shown in FIG. 16, the rods 865 of the deflector support members 850, which slide between a position within the housing members 855 and an extended position, are each about 1.28 inches in length. Each rod 865 has a frustoconical portion 1610 at the top, which is about 0.29 inches in length and forms an angle of about 4.5° with respect to the longitudinal axis of the rod. The diameter of the frustoconical portion 1610 is about 0.155 inches at the top end and about 0.11 inches at the bottom end.

A conical void 1620, which has a length of about 0.07 inches, an opening diameter of about 0.85 inches is formed in the end of the rod 8165. The conical void 1620 aids in material flow during the formation of the frustoconical portion 1610 of the rod 865. The frustoconical portion 1610 helps hold the rod 865 in rigid position at the bottom of the housing member 855 in the deployed position. While in the preferred embodiment the rod has a void in an end thereof, the present invention is not limited to this configuration and may include solid rods without a void or indentation, or hollow rods.

The frustoconical portion 1610 is followed by a first cylindrical portion 1630 of about 0.56 inches in length and a diameter of about 0.11 inches. A second cylindrical portion 1640 of about 0.30 inches in length and about 0.93 inches in diameter is formed, and the top end of this portion blended to the surface of the first cylindrical portion by a curved surface 1650 having a radius of 0.08 inches. A third cylindrical portion 1660 having a length of about 0.115 inches and a diameter of about 0.082 inches is formed at the bottom of the rod 865. The surface of the third cylindrical portion 1660 is blended to the surface of the second cylindrical portion 1640 by a curved surface 1670 having a radius of about 0.08 inches.

When the sprinkler is deployed (see FIG. 9), the first frustoconical portion 1610 of the rod 865 lodges in the second frustoconical portion 1535 and third cylindrical portion 1540 of the housing member. By using the above described configuration, the deflector is more stable when deployed, allowing for a consistent sprinkler spray pattern. By contrast, without such a configuration, the force of the fluid output may cause the deflector to wobble or shift to, and possibly jam in, an askew position, resulting in an undesirable spray pattern.

The stability of this configuration is in part attributed to the resiliency in the first frustoconical portion 1610 of the rod 865, which provides a substantially locking fit between the rod 865 and the housing member 855. This in turn provides stability to the deployed deflector 845 when it is exposed to the stream of output fluid, thereby preventing undesirable vibration or movement of the deflector 845. It should be understood that the invention is not limited to this particular configuration, and may include other deflector support members.

The deflector 845, which is shown in detail in FIGS. 17 and 18, has an opening 1710 in the middle that is configured to receive a conical member 1720. The conical member 1720, which has an outer diameter of 0.7 inches and an included angle of 130°, faces the output orifice 830 to assist in the dispersion of the output fluid and to improve the stability of the deployed deflector 845. A conical indentation 1730 having an included angle of about 118° to about 120° is formed in the base of the conical member 1720 (which has a diameter of 0.245 inches) to allow it to achieve a secure press fit in the opening 1710 of the deflector 845. The conical member 1720 also helps prevent the seal cap 835 and other ejected components from becoming lodged behind the deflector 845 upon deployment of the sprinkler.

The deflector 845 has radial slots 1740 around the perimeter thereof, arrayed around the opening 1710 for the conical member 1720. The slots 1740 extend inward to within a distance of the opening 1710 to form a generally circular central portion 1750 of the deflector 845 surface. Two tab portions 1760 extend from the sides of the deflector 845 with a downward angle of about 10° (with respect to the plane of the deflector) to provide mounting holes 1770 for the rods 865 extending from the deflector support members 850. The outer edges 1780 of the other two sides of the deflector are linear (see FIG. 17).

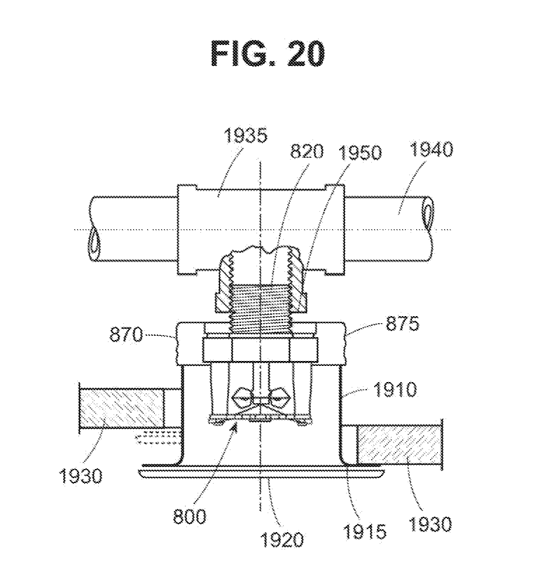

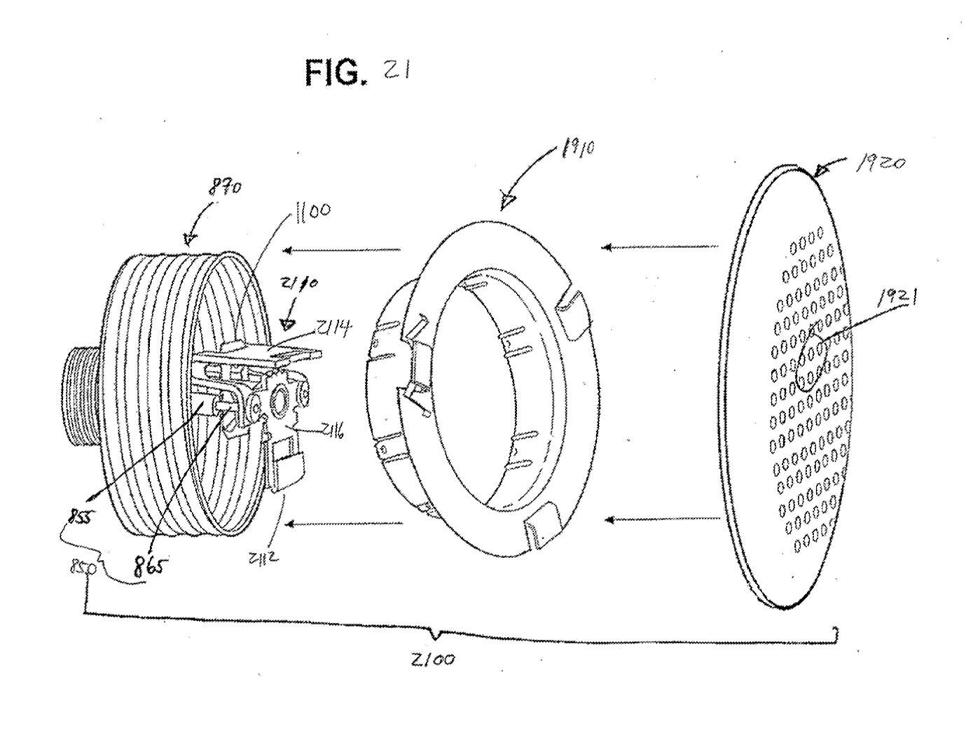

As shown in FIGS. 19 and 20, the sprinkler 8100 installs within a support cup 870, escutcheon 1910, and cover 1920 assembly, to form a concealed configuration. The cover 1920 is perforated, having a plurality of openings 1921 therein which permit air to pass through the cover 1920. Such a configuration is particularly desirable for residential applications due to its low profile and aesthetically pleasing appearance. The escutcheon 1910, which is cylindrical and has a circumferential flange 1915 on its outwardly facing end, installs with a press or threaded fit into the ridged outer surface (walls 875) of the support cup 870. The escutcheon 1910 is formed of metal, e.g., copper alloy.

A flat, circular cover 1920, which also is formed of metal, e.g., brass, is mounted on raised portions around the periphery of the escutcheon flange 1915 (see FIG. 20). The cover 1920 attaches to these raised portions with solder that is designed to melt at a predetermined temperature, e.g., 135° F., to allow for release of the cover 1920. The raised portions result in a gap between the cover 1920 and the escutcheon 1910, which allows air flow to reach the sprinkler 800. The cover 1920 includes at least one perforation which allows air flow to reach the sprinkler 800. The release of the cover 1920 allows the deflector 845 to drop down into the deployed position. At a second predetermined temperature, e.g., 165° F., the fusible soldered link 1100 separates, as described above, to initiate the flow of fluid from the sprinkler.

To install the sprinkler, the support cup 870, which has a diameter of, e.g., 2.28 inches, is inserted in a cavity in the ceiling 1930 having a diameter of, e.g., about 2⅝ inches, and the threaded base 820 of the sprinkler is connected to the output fitting 1935 of a conduit 1940. The escutcheon 1910 and cover 1920 assembly is then installed in the support cup 870 so that the escutcheon flange 1915 rests on the outer surface of the ceiling 1930 (the outer surface of the cover is about 3/16 inches from the surface of the ceiling due to the gap between the flange and cover).

The support cup 870 and escutcheon 1910 are configured to allow for an adjustment to accommodate variations in the distance between the face 1950 of the conduit output fitting 1935 and the surface of the ceiling 1930, which is referred to as the “field adjustment.” The field adjustment is sometimes needed, because the deflector 845 must be properly located below the ceiling 1930 in its deployed position, but it is difficult to precisely position sprinkler conduits 1940 with respect to the ceiling 1930 surface, due to the practicalities of building construction. To ensure the correct position of the deployed deflector 845, the distance between the face 1950 of the conduit output fitting 1935 and the ceiling 1930 should not be more than 2 inches.

The field adjustment is achieved by allowing the escutcheon 1910 to be positioned with a varying degree of overlap with the outer walls 875 of the support cup 870. The support cup 870 and escutcheon 1910 are configured so that any secure engagement between these components results in a proper position for the deployed deflector 845.

The amount of field adjustment, which in this example is 0.5 inches, is determined by the length of the rods 865 of the deflector support members 850, because the length of the rods 865 determines the amount of variation that can be accommodated in the position of the conduit 1940 relative to the ceiling line 1930. In other words, the rods 865 may be completely retracted within the housing member 855 before deployment, such as when the conduit 1940 and, therefore the sprinkler 800, is positioned as close as possible to the ceiling line 1930. Alternatively, the rods 865 may be nearly ¾ extended before deployment, such as when the conduit 1940 is positioned as far as possible above the ceiling line 1930. The length of the rods 8165, in turn, determines the height of the outer walls 875 of the support cup 870. Thus, the outer walls 875 of the support cup 870 must have a height of slightly more than 0.5 inches in the example described herein.

Configuring the deflector support members 850 such that the rods 865 extend through the housing members 855 and the flange 840 allows for the use of a shallower cup, because the depth of the support cup is primarily determined by the length of the rods 865. This in turn results in the thermally-responsive element being located closer to the ceiling line, thereby improving sprinkler sensitivity. By contrast, in conventional concealed sprinklers, the guide pins coupled to the deflector are generally positioned below the flange, thereby requiring a deeper support cup (because the depth of the support cup is determined by the length of the guide pins plus the flange thickness). Consequently, the thermally-responsive element is located farther from the ceiling line, resulting in reduced sprinkler sensitivity.

In another embodiment shown in FIG. 21, a horizontal sidewall sprinkler 2110 is constructed utilizing much of the structure of the pendent sprinkler 800 described hereinabove and shown in FIGS. 8-20. For example, as shown in FIG. 21, the sprinkler 2110 is constructed having the same elements as the pendent sprinkler 800 except that a horizontal deflector 2112 is substituted for the deflector 845, which is better suited for the pendent sprinkler configuration. The deflector 2112 is coupled to the two deflector support members 850 on opposite sides of the sprinkler body 810. Each of the support members 850 includes housing member 855, which extends in the fluid output direction, and rod 865, which is movable with respect to the housing member 855. A horizontal shelf 2114 of the deflector 2112 extends in the output direction in a plane parallel to a plane passing through the two deflector support members 850. A vertical face 2116 is connected to the horizontal shelf 2114 and is connected to ends of rods 865. The vertical face 2116 extends in a plane that is substantially transverse to the horizontal shelf 2114. The horizontal shelf 2114 may also be angled upward slightly to achieve a desired spray pattern.

The sprinkler 2110 operates in the same manner as sprinkler 800 described hereinabove. That is, the operation and movement of the deflector 2112 and deflector support members 850 shown in FIG. 21, are the same as described above with respect to the corresponding elements of the embodiment of the pendent sprinkler 800.

The sprinkler 2110 is mounted in support cup 870. The support cup 870 is configured to receive escutcheon 1910, which is constructed to be releasably attached to cover 1920, such as by a fusible solder connection. When assembled, the sprinkler 2110, support cup 870, escutcheon 1910, and cover 1920 form a horizontal sidewall concealed sprinkler assembly 2100 which can be partially recessed within a wall to connect to a fluid supply therein. While the escutcheon 1910, cover 1920, support cup 870, and the sprinkler 2110 may be formed as separate components, they may also be formed together either integrally or as subassemblies, in any combination.

When the sprinkler 2110 is recessed within the wall, the cover 1920 is constructed to permit suitable air flow to reach the fusible soldered link 1100 so that the sensitivity of the sprinkler 2110 remains within acceptable limits. Accordingly, by virtue of the perforated and substantially flat cover 1920, the horizontal sidewall sprinkler 2110 can be concealed without the use of a conventional frustoconical covers which protrude farther from the surface of the wall. To some observers, the horizontal sidewall concealed sprinkler assembly 2100 is more visually pleasing when mounted in the wall than conventional concealed horizontal sidewall concealed sprinkler arrangements.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims.

1. An aesthetic cover to conceal a cover plate of a concealed fire protection sprinkler, the cover plate having an inner side facing the sprinkler and a wall or ceiling surface and an outer side facing away from the sprinkler, the cover comprising:
a concealing surface; and
an attachment member configured to attach the concealing surface to the cover plate so as to conceal the cover plate.

2. The aesthetic cover of claim 1, wherein the concealing surface includes at least one aperture formed therein.

3. The aesthetic cover of claim 1, wherein the attachment member is configured to attach to the cover plate with an adhesive or glue.

4. The aesthetic cover of claim 1, wherein the attachment member includes at least one aperture formed therein.

5. The aesthetic cover of claim 1, wherein the attachment member includes a surface configured to conform to at least a portion of the outer surface of the cover plate.

6. The aesthetic cover of claim 1, wherein the attachment member includes at least one slot configured to receive and retain the concealing surface.

7. The aesthetic cover of claim 6, wherein the attachment member includes an opening configured to receive the cover plate therethrough.

8. The aesthetic cover of claim 7, wherein the opening includes at least one tab extending in the opening that is configured to attach to the cover plate.

9. The aesthetic cover of claim 8, wherein the attachment member is configured to be attached to the concealing surface with an adhesive or glue.

10. The aesthetic cover of claim 1, wherein the concealing surface is configured to be spaced a predetermined distance from the wall or ceiling.

11. The aesthetic cover of claim 8, wherein the attachment member includes at least one side having a free edge extending from the attachment member towards the wall or ceiling.

12. The aesthetic cover of claim 11, wherein the free edge includes at least one tab extending from the free edge towards the wall or ceiling, wherein the length of the tab is less than the length of the free edge.

13. The aesthetic cover of claim 11, wherein the free edge includes edging attached thereto.

14. The aesthetic cover according to claim 1, wherein the cover plate is configured to release from the concealed sprinkler prior to the activation of the sprinkler.

15. The aesthetic cover according to claim 1, wherein the cover plate is configured to release from the concealed sprinkler at a temperature of 120° F.

16. An dual sprinkler cover assembly to conceal a cover plate of a concealed fire protection sprinkler,
a cover plate releasably connected to the concealed fire protection sprinkler configured to conceal the fire protection sprinkler;
a concealing surface; and
an attachment member configured to attach the concealing surface to the cover plate so as to conceal the cover plate, wherein the fire protection sprinkler is configured to activate at a first predetermined temperature and the cover plate is configured to release from the fire protection sprinkler at a second predetermined temperature that is less than the first predetermined temperature.

17. The dual sprinkler cover assembly of claim 16, wherein the first temperature includes one of 135° F. and 165° F.

18. The dual sprinkler cover assembly of claim 17, wherein the second temperature is 120° F.

19. A concealed sprinkler arrangement comprising:
a fire protection sprinkler, comprising:
a body having an output orifice and a flange;
a seal cap to seal a flow of fluid from the output orifice;
a thermally-responsive element positioned to releasably retain the seal cap, and to release the seal cap at a first predetermined temperature;
a plurality of housing members extending from the flange;
a plurality of rods, each rod slidably contained within one of the housing members and extending into the flange; and
a deflector connected to ends of the rods, wherein each of the rods comprises at least one cylindrical portion and at least one frustoconical portion, and each of the housing members comprises at least one cylindrical portion and at least one frustoconical portion, and at least one frustoconical portion of the rod lodges in at least one frustoconical portion of the housing member;
a support cup configured to support the fire protection sprinkler;
an escutcheon removably attached to the support cup, the escutcheon having an annular flange; and
a substantially planar perforated cover removably attached to the escutcheon, wherein the cover is configured to detach from the escutcheon at a second predetermined temperature that is less than or equal to the first predetermined temperature.

20. The concealed sprinkler arrangement according to claim 19, wherein the fire protection sprinkler includes at least one of a pendent and a sidewall sprinkler.

21. The concealed sprinkler arrangement according to claim 20, wherein where the support cup, the escutcheon, and the fire protection sprinkler are coaxial with an axis through the output orifice.

22. A fire protection sprinkler including:
a fire protection sprinkler, comprising:
a body having an output orifice and a flange;
a seal cap to seal a flow of fluid from the output orifice;
a thermally-responsive element positioned to releasably retain the seal cap, and to release the seal cap at a first predetermined temperature;
a plurality of housing members extending from the flange;
a plurality of rods, each rod slidably contained within one of the housing members and extending into the flange; and
a deflector connected to ends of the rods, wherein each of the rods comprises at least one cylindrical portion and at least one frustoconical portion, and each of the housing members comprises at least one cylindrical portion and at least one frustoconical portion, and at least one frustoconical portion of the rod lodges in at least one frustoconical portion of the housing member;
a support cup configured to support the fire protection sprinkler;
an escutcheon removably attached to the support cup, the escutcheon having an annular flange; a substantially planar perforated cover removably attached to the escutcheon, wherein the cover is configured to detach from the escutcheon at a second predetermined temperature that is less than or equal to the first predetermined temperature; and
a fitting constructed to fluidly connect to the body of the sprinkler, wherein the fitting includes a base constructed to be attached to a wall or ceiling stud.

23. The system of claim 23, wherein the fitting has at least one of a threaded connector and a crimp-type connector.

24-26. (canceled)
